(19) United States
(12) Patent Application Publication
(10) Pub. No.: US 2013/0050143 A1
(43) Pub. Date: Feb. 28, 2013

(54) METHOD OF PROVIDING OF USER INTERFACE IN PORTABLE TERMINAL AND APPARATUS THEREOF

(71) Applicants: Tae Yeon KIM, Seoul (KR); Mi Jung PARK, Gyeonggi-do (KR); Gu Hyun YANG, Seoul (KR)

(72) Inventors: Tae Yeon KIM, Seoul (KR); Mi Jung PARK, Gyeonggi-do (KR); Gu Hyun YANG, Seoul (KR)

(73) Assignee: SAMSUNG ELECTRONICS CO., LTD., Gyeonggi-Do (KR)

(21) Appl. No.: 13/595,157

(22) Filed: Aug. 27, 2012

(30) Foreign Application Priority Data
Aug. 31, 2011 (KR) 10-2011-0087832
Jul. 16, 2012 (KR) 10-2012-0077301

(51) Int. Cl. G06F 3/044; G06F 3/046; G06F 3/045; G06F 3/041

(52) U.S. Cl. 345/174; 345/173

(57) ABSTRACT

Provided are a method of providing a user interface of a portable terminal that may output an affordance image induced such that a certain function is performed in a location in which approach of a touch input device is sensed, and an apparatus thereof. The method of providing a user interface of a portable terminal with a touch screen, includes: checking whether approach of a touch input device is sensed on the touch screen; determining a type of the sensed touch input device when the approach of the touch input device is sensed; and outputting a first affordance image corresponding to at least one function executable using a stylus at a sensed region of the approach of a stylus when the touch input device is the stylus as the determination result.

### CLAIM OF PRIORITY

This application claims, pursuant to 35 USC 119(a), claims priority from and the benefit of the earlier filing date of a patent application filed in the Korean Intellectual Property Office on Aug. 31, 2011 and afforded serial number 10-2011-0087832, and Jul. 16, 2012 and afforded serial number 10-2012-0077301, the contents of which are incorporated by reference herein in its entirety.

### BACKGROUND OF THE INVENTION

1. Field of the Invention

The present invention relates to a method of providing a user interface of a portable terminal, and an apparatus thereof, and more particularly, to a method and an apparatus for providing a user interface for the touch input device when approach of a touch input device is sensed.

2. Description of the Related Art

In recent years, with the significant development of information, communication and semiconductor technology, the availability and use of all types of portable terminals has rapidly increased. In particular, recent portable terminals have been developed that converge traditional portable terminal functions as well as functions that were previously not available on portable terminals. As a representative example of the portable terminal functions, a mobile communication terminal can provide various functions such as a TV watching function (e.g., mobile broadcasting such as Digital Multimedia Broadcasting (DMB) or Digital Video Broadcasting (DVB)), a music playing function (e.g., MPEG Audio Layer-3 (MP3)), a photographing function, and an Internet access function as well as a general communication function such as speech call or text/multimedia message transmission/reception.

As more and varied functions are provided, there is a need to enable the user to control the portable terminal rapidly and conveniently. Due to this need, portable terminals with a touch screen have recently developed. The touch screen may sense contact of a touch input device such as a finger or a stylus to generate an output at a contacted location. For example, when a touch occurs on an electromagnetic induction touch screen, the capacitance of a touched point varies. When the variation of capacitance exceeds a preset threshold, it is determined that a touch event is occurring. Through an algorithm that receives a signal of the capacitance variation, the location of the touch event may be determined by the algorithm.

Typically, a conventional portable terminal has provided the same user interface without discriminating a finger or a stylus being a touch input scheme of a touch screen. Accordingly, there is a problem in that a function of a user interface provides on the touch screen or an image of a corresponding function has an unnecessary complex configuration. For example, when touch input is performed using a finger, unnecessary functions specified in a stylus having a small touch region may be displayed.

There is inconvenience that the conventional portable terminal needs to perform a plurality of touch operations such as a touch for display a function screen of a user interface and a touch for executing a desired function on a function screen to execute the desired function.

### SUMMARY OF THE INVENTION

The present invention has been made in view of the above problems, and provides a method and an apparatus of providing a user interface of a portable terminal that outputs an affordance image when approach of a touch input device is sensed.

The present invention further provides a method of providing a user interface of a portable terminal that may output different affordance images according to types of input devices utilized on the portable terminal by the user.

In accordance with an aspect of the present invention, a method of providing a user interface of a portable terminal with a touch screen, includes: checking whether approach of a touch input device is sensed on the touch screen; determining a type of the sensed touch input device when the approach of the touch input device is sensed; and outputting a first affordance image corresponding to at least one function executable using a stylus at a sensed region of the approach of the stylus when the touch input device is the stylus as the determination result.

In accordance with another aspect of the present invention, an apparatus for providing a user interface of a portable terminal, includes: a touch panel recognizing approach and touch of a touch input device; a controller determining a type of the touch input device when approach of the touch input device is sensed, and controlling such that a first affordance image corresponding to at least one function executable using a stylus is displayed at a side of a sensed region of approach of the stylus when the touch input device is the stylus as the determination result; and a display panel outputting the first affordance image.

In accordance with still another aspect of the present invention, a method of providing a user interface of a portable terminal with a touch screen, includes: sensing approach of a stylus; and outputting an affordance image corresponding to at least one function executable using the stylus at a sensed region of the approach of a stylus when the approach of the stylus is sensed.

In accordance with yet another aspect of the present invention, an apparatus for providing a user interface of a portable terminal, includes: a touch screen sensing approach of a stylus; and a controller for controlling the touch screen to output an affordance image corresponding to at least one function executable using the stylus at a sensed region of the approach of the stylus when the approach of the stylus is sensed.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating an exemplary configuration of a portable terminal and a stylus according to an embodiment of the present invention;

FIG. 2 is a view illustrating an exemplary method of sensing approach of a touch input device according to an embodiment of the present invention;

FIG. 3 is a flowchart illustrating an exemplary method of providing a user interface of a portable terminal according to an embodiment of the present invention;

FIG. 4 is a view illustrating an exemplary screen for expressing an example of an interface providing an affordance image when a stylus approaches a schedule management screen according to an embodiment of the present invention;

FIG. 5 is a view illustrating an exemplary screen for expressing an example of an interface providing an affordance image when a stylus approaches a home screen according to an embodiment of the present invention; and

FIG. 6 is a view illustrating an exemplary screen for expressing an example of an interface providing an affordance image when a stylus approaches a screen of an address book.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the present invention by a person of ordinary skill in the art with unnecessary detail of the well-known functions and structures. Also, the terms used herein are defined according to the functions of the present invention as would be understood by a person of ordinary skill in the art. Thus, the terms may vary depending on user's or operator's intension and usage. That is, the terms used herein must be understood based on the descriptions made herein in view of the ordinary level of skill in the art. As utilized in this detailed description, a portable terminal according to an embodiment of the present invention may be an electronic device with a touch screen, and may include a mobile communication terminal, a personal digital assistant (PDA), a smart phone, a tablet personal computer (PC), and a Portable Multimedia Player (PMP), although this description is not limited to only such terminals. One skilled in the will recognize that a portable terminal may include other portable electronic devices incorporating a touch screen with a processor for computing and/or communication

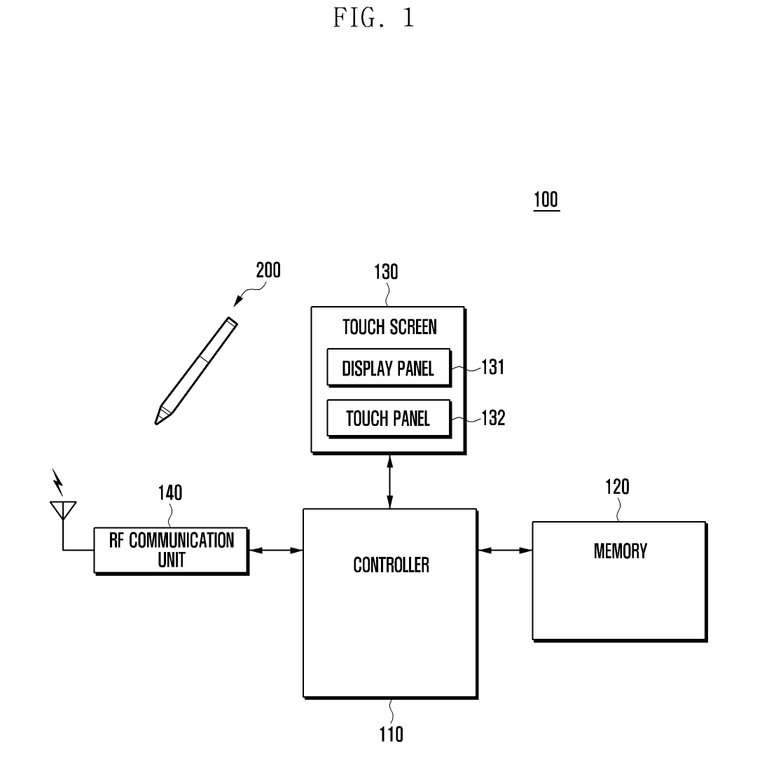

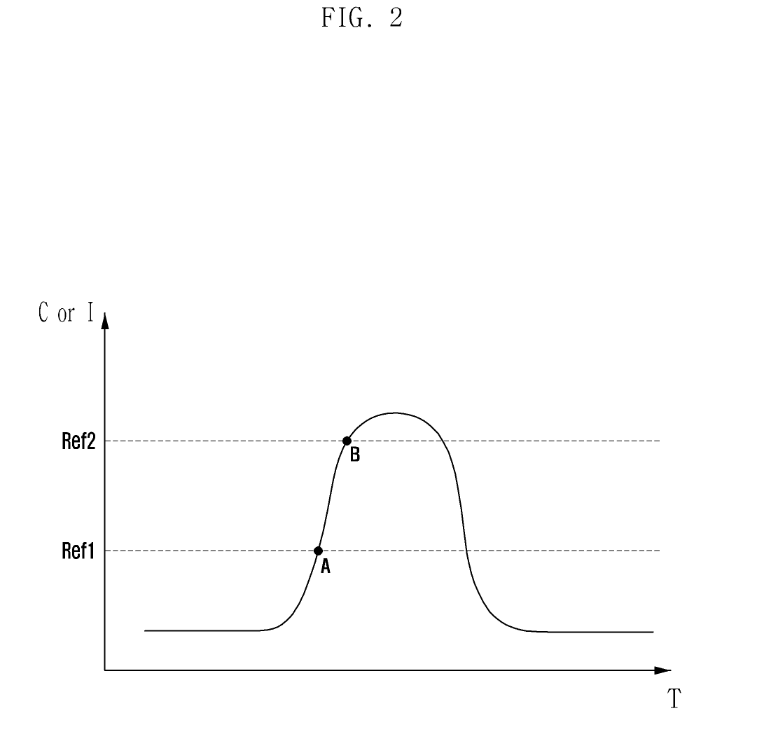

FIG. 1 is a block diagram illustrating a configuration of a portable terminal 100 and a stylus 200 according to an exemplary embodiment of the present invention. FIG. 2 is a view illustrating the variation of capacitance or electric current in a touch panel for a method of sensing approach of a touch input device according to an embodiment of the present invention.

Referring to FIG. 1 and FIG. 2, a portable terminal 100 according to an embodiment of the present invention may include a radio frequency (RF) communication unit 140, a touch screen 130, a memory 120, and a controller 110. The touch screen 130 may include a display panel 131 and a touch panel 132.

The stylus 200 is a touch input device in the form of a pen which may be used on an electromagnetic induction touch panel. To do this, the stylus 200 may include a resonance circuit. The resonance circuit may resonate by electromagnetic field generated on the touch screen 130, and generate an induction current due to the resonance. The induction current generated by the resonance may cause current variation in the touch screen 130. That is, the touch screen 130 may recognize and react to the approach and touch of the stylus 200 through current variation due to the induction current. The design and construction of foregoing stylus 200 including a resonance circuit will be apparent to a person having ordinary skill in the art to which the invention pertains and is known in the art, and thus the detailed description thereof is omitted.

The RF communication unit 140 may form a communication channel for calls (voice and image calls) with a base station and a data communication channel for data transmission. To do this, the RF communication unit 110 may include a transmitter (not shown) for up-converting a frequency of a transmitted signal and amplifying the signal, a receiver (not shown) for low-noise-amplifying a received signal and down-converting the signal, and a transmission/reception separator (not shown)for separating the received signal from the transmitted signal.

The touch screen 130 may perform an input function and an output function. To do this, the touch screen 130 may include a display panel 131 for performing an output function and a touch panel 132 for performing an input function. The touch panel 132 may be configured as a combination touch panel being a combination of an electromagnetic induction scheme and a capacitive scheme. Further, the touch panel 132 may be configured by a combination touch panel being a combination of the electromagnetic induction scheme and a resistive scheme.

The touch panel 132 is provided in a front surface of the display panel 131, and generates a touch event according to touch of a touch input device, for example, a user finger or the stylus 200, and transfers the generated touch event to the controller 110. The touch panel 132 may recognize touch through variation in a physical property (e.g., capacitance, electric current, etc.), and transfer the type of touch (tap, drag, flick, double touch, long touch, multi touch, etc.) and touched positional information to the controller 110. The foregoing touch panel 132 will be apparent to a person having ordinary skill in the art to which the invention pertains, and thus the detailed description thereof is omitted. In particular, the touch panel 132 of the present invention may sense approach, touch, approach release, and touch release of the touch input device. This will be described with reference to FIG. 2, the touch input device is slowly approached, contacts and then a contact is released, capacitance C or an electric current I vary as illustrated in FIG. 2. Here, if the variation in capacitance C or the electric current I is equal to or greater than a first reference value A, the touch panel 132 recognizes approach (e.g., 1˜2 cm) of a touch input device. If the variation in the capacitance C or the electric current I is equal to or greater than a second reference value B, the touch panel 132 may recognize that a touch input device contacts (touches) the touch panel 132.

Meanwhile, the variation in the capacitance C and the electric current I has been described using the same graph of FIG. 2. It will be apparent to those skilled in the art that a variation graph of the capacitance C and a variation graph of the electric current I have the same form but are not perfectly identical with those of FIG. 2.

In this case, when the touch panel 132 is a combination touch panel including a capacitive touch panel and an electromagnetic induction touch panel, the capacitive touch panel may sense the approach contact (touch) and contact (touch) release of a finger, and the electromagnetic induction touch panel may sense the approach, contact (touch), and contact (touch) release of the stylus 200.

In accordance with the present invention, so as to output an affordance image only when approach of the stylus 200 is sensed, the touch panel 132 may become a combination touch panel in which an electromagnetic induction touch panel and a resistive touch panel are combined with each other.

The display panel 131 displays information input by the user or information provided to the user as well as various menus of the portable terminal 100. That is, the display panel 131 may provide various screens according to utilization of the portable terminal 100. For example, an idle screen (home screen), a menu screen, a message creation screen, a call screen, a schedule management screen, and an address book screen. In particular, when approach of the touch input device is sensed, the display panel 131 of the present invention may output an affordance image under the control of the controller 110. This will be described in detail with reference to an example of a screen. The display panel 131 may be configured in the form of a flat panel display such as a Liquid Crystal Display (LCD), an Organic Light Emitted Diode (OLED), or an Active Matrix Organic Light Emitted Diode (AMOLED).

The memory 120 may store an Operating System (OS) of a portable terminal 100, and an application program necessary for enabling other options and functions. Other options and functions may include, for example, a voice playback function, an image or moving image playback function, a broadcasting playback function, a user data communication function. For example, the memory 120 may store a key map or a menu map for operating the touch screen 130. Here, the key map or the menu map may be configured in various forms, respectively. For example, the key map may become a key board map, a 3*4 key map, a QWERTY key map, or a control key map for controlling operation of a currently activated application program. Furthermore, the menu map may become a menu map for controlling an operation of a currently activated application program. The memory 120 may store character messages, game files, music files, movie files, and contact information.

Particularly, when a touch input device approaches, the memory 120 according to the present invention may store a program outputting an affordance image. The affordance image may be changed according to a type of approached item or a type of touch input device. For example, when the stylus 200 approaches a certain schedule of a screen, the affordance image may become a time change image to which a time change function of a schedule is set. When the stylus 200 approaches a certain icon of a home screen, the affordance image may become a moving affordance image to which a moving function of an icon is set. When the stylus 200 approaches certain contact information of an address bock screen, the affordance image may become a function affordance image including frequently used functions, namely, a call icon, a character icon, an e-mail icon, and an instant message icon. Alternately, if a finger approaches a certain schedule of the schedule management screen, the affordance image may become a delete affordance image to which a schedule delete function is set. When a finger approaches a certain icon of a home screen, the affordance image may become a copy affordance image to which an icon copy function is set. When the finger approaches certain contact information of the address book screen, the affordance image may not be output. However, this is one exemplary embodiment but does not limit the present invention. That is, a function set to an affordance image output upon approaching the touch input device for any particular application may be variously changed according to intention of a designer.

In the meantime, the memory 120 may set ON/OFF of an affordance display mode displaying the affordance image, and store a program changing a function set to the affordance image. That is, if the touch input device approaches when the user activates an affordance image display mode, then program may output the affordance image. Moreover, the program may change a function set in the affordance image to a function requested by the user.

The controller 110 may control an overall operation of the portable terminal 100 and signal flow between internal blocks of the portable terminal 100, and perform a data processing function processing data. Particularly, when approach of the touch input device is sensed, the controller 110 according to the present invention outputs preset affordance image. When a touch event occurs on the affordance image, the controller 110 may control the respective structural elements such that a function in the affordance image is performed. In this case, the controller 110 may output another affordance image according a type of a touch input device (e.g., finger or stylus 200) approaching the touch screen 130. The controller 110 will be described in detailed with reference to FIG. 2 to FIG. 6.

The portable terminal 100 according to the present invention may selectively include structural elements for providing additional functions such as a camera module for taking images or moving images, a transmitting/receiving module for receiving or broadcasting data or voice communications, a digital sound source playback module such as an MP3 module, a near distance wireless communication module such as a Bluetooth transmitter, and a proximity sensor module for proximity sensing. Since the structural elements can be variously changed according to the particular requirements of a particular digital device, no elements can be listed. However, the portable terminal 100 may include structural elements equivalent to the foregoing structural elements.

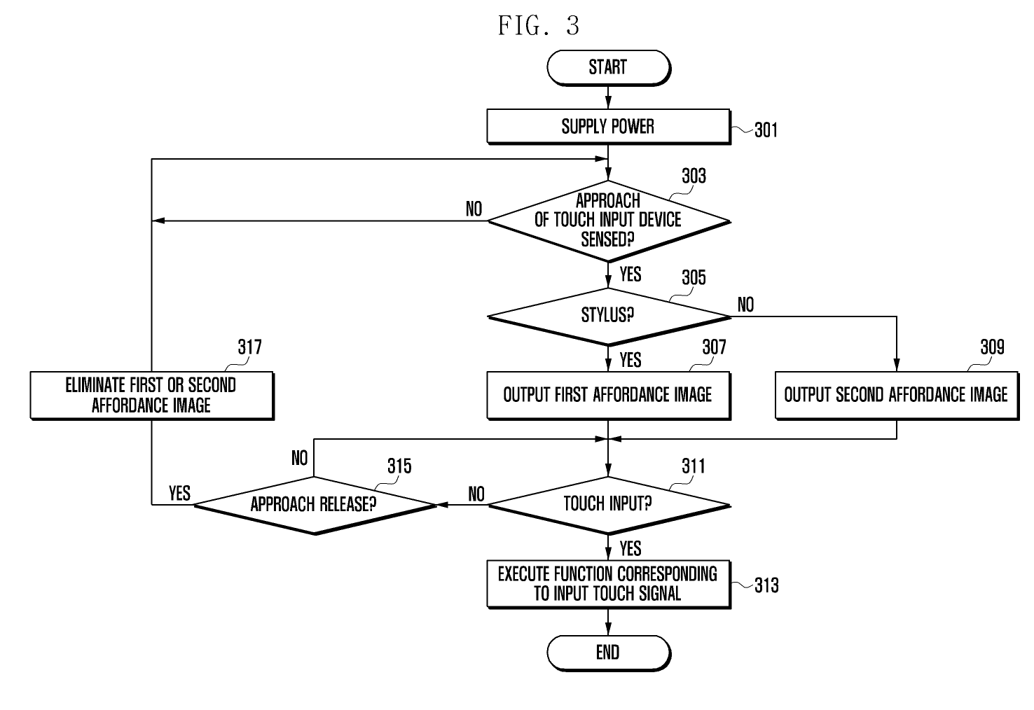

FIG. 3 is a flowchart illustrating a method of providing a user interface of a portable terminal according to an embodiment of the present invention. Hereinafter, a combination touch panel in which a capacitive touch panel and an electromagnetic induction touch panel are combined will be explained by way of example.

Referring to FIG. 1 to FIG. 3, a controller 110 of a portable terminal 100 according to an embodiment of the present invention may control power from a power supply that is supplied to respective structural elements of the portable terminal 100 (301). Next, the controller 110 may check whether approach of a touch input device (e.g., stylus 200, finger, etc.) is sensed (303). In detail, if the touch input device approaches a touch screen 130, capacitance or an electric current varies. The touch panel 132 senses variation in the capacitance or the electric current and transfers the sensed variation to the controller 110. When the transferred variation in the capacitance or the electric current is equal to or greater than a first reference value, the controller 110 may determine that the touch input device approaches a predetermined region of the touch screen 130. In this case, the controller 110 may output a location in which approach of the touch input device is sensed. If the approach of the touch input device is not sensed, the controller 110 may maintain step 303 and continue to monitor for the approach of a touch input device. Conversely, if the approach of the touch input device is sensed, the controller 110 may determine a type of the touch input device in which the approach is sensed (305). For example, the controller 110 may determine whether the sensed touch input device is a stylus 200 or a finger. Determination of a type of the touch input device may use various known technologies. To do this, when approach is sensed in a capacitive touch panel, the controller 110 determines that a finger approaches. When approach of an electromagnetic induction touch panel is sensed, the controller 110 may determine that the stylus 200 approaches. However, the present invention is not limited thereto. That is, the present invention may use other various known techniques as a technology determining a type of the touch input device.

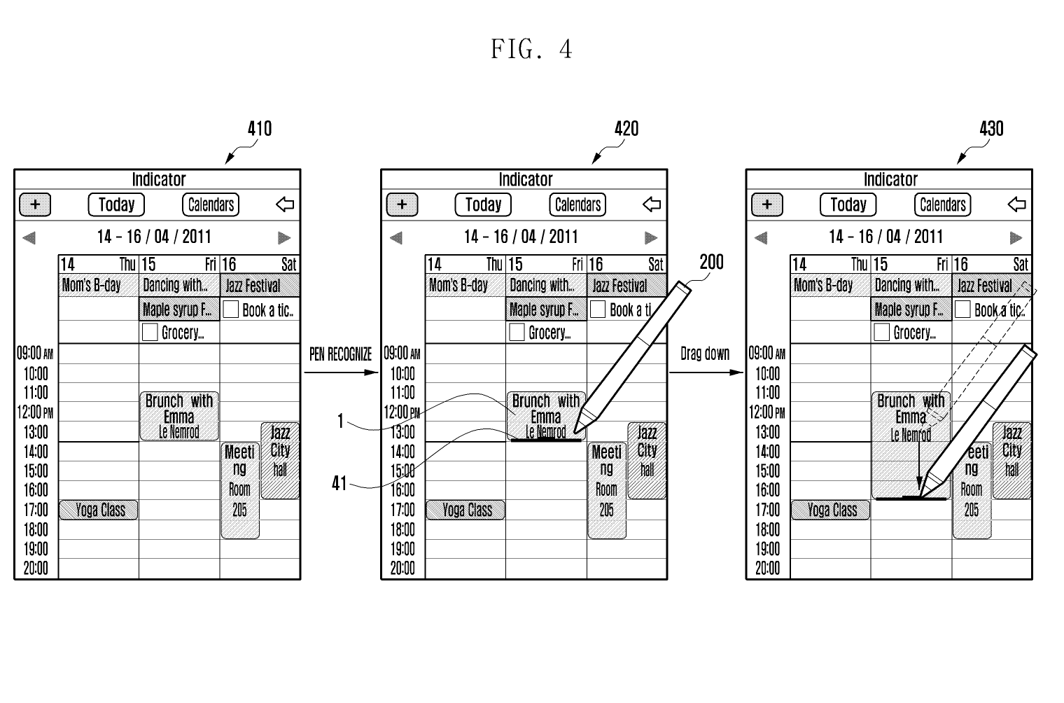

After reaching a determination result, that the sensed touch input device is the stylus 200, for example, approach of the stylus 200 is sensed through electromagnetic induction touch panel, the controller 110 may output a first affordance image at a sensed location of the approach (307). The first affordance image may include at least one icon for inducing execution of a function (function for which precise touch is requested) specified in the stylus 200. This will be described in detail with reference to FIG. 4 to FIG. 6.

Conversely, when the sensed touch input device is not the stylus 200, for example, when approach of a touch input device distinguished from said stylus (e.g. the finger) is sensed through a capacitive touch panel, the controller 110 may output a second affordance image distinguished from the first affordance image (309). The second affordance image may include functions that do not require precise handling or touch like the stylus 200.

Next, the controller 110 may determine whether a touch input signal is generated (311). To do this, the controller 110 may check whether variation in the capacitance or electric current occurs by greater than the second reference value to determine touch. In this case, after performing step 307, in step 311 it is determined whether a touch event occurs within an image display region or in another region. After performing step 309 or 307, in step 311 it is determined whether a touch event occurs within a second affordance image display region or another region.

If the touch input signal is not generated, the controller 110 may determine whether a signal corresponding to an approach release of the touch input device is input (315). When the signal corresponding to the approach release of the touch input device is input, the controller 110 eliminates the first affordance image or the second affordance image (317), and the process returns to step 303, and the forgoing procedure may repeat iteratively in accordance with the application or function being accessed by the user.

Conversely, when the touch input signal is generated, the controller 110 may control such that a function corresponding to a touch signal input is performed (313). For example, when a touch event occurs on the first affordance image, the controller 110 may execute a function set in the first affordance image. When a touch event occurs on the second affordance image, the controller 110 may execute a function set in the second affordance image. When a touch event occurs on another region (e.g., item), the controller 110 executes a function set in another function. If the function corresponding to the input touch signal is terminated, the process returns to step 303 and the controller 110 may repeat the foregoing procedures.

In a state that approach of the touch input device is sensed to output the first affordance image or the second affordance image, and when touch of the touch screen 130 is not sensed however movement of the touch input device is sensed, the controller 110 may control the first affordance image or the second affordance image is moved according to movement of the touch input device.

Further, when the touch input device is moved, the affordance image may be changed according to an attribute of an item existing in a location which approach of the touch input device is sensed. For example, when approach of the touch input device is sensed on a music file item, an affordance image including a function (playback, stop, addition in a playback file list) is outputted. When the touch input device is moved on a shortcut item with respect to a contact point of an individual user, the controller 110 may output an affordance image including a function (call, character message, e-mail, etc.) associated with the contact point.

Further, the foregoing embodiment has illustrated that the controller 110 controls such that the second affordance image is output when a touch input device approaching the touch screen 130 is not the stylus 200 for example, when approach of a finger is sensed through a capacitive type touch panel. However, another embodiment of the present invention may process such that approach of the touch input device, other than the stylus 200 is disregarded. For example, when the touch input device other than the stylus 200 is approached, the controller 110 may control such that no image is outputted. That is, in another embodiment of the present invention, only when approach of the stylus 200 is sensed, the controller 110 may control such that a preset affordance image may be output. When the affordance image is output only where approach of the stylus 200 is sensed, the touch panel 132 may be configured by a combination touch panel being a combination of an electromagnetic induction type touch panel for sensing approach of the stylus 200 and a touch panel of various schemes (e.g., capacitive type, resistive type) capable of sensing a touch of a finger. The touch input device distinguished from said stylus may include touch gloves, a stick, and conductive stylus, etc.

The present invention may further include a step of determining whether an affordance display mode is activated after step 301 or step 303. To reach the determination result, when the affordance image display mode is activated, the controller 110 performs following procedures. When the affordance image display mode is not activated, the controller 110 may sense only a touch event generated on the touch screen 130, and perform a function according to the sensed touch event.

FIG. 4 is a view illustrating an example of a screen for expressing an example of an interface providing an affordance image when a stylus approaches a schedule management screen according to an embodiment of the present invention.

Referring to FIG. 1 to FIG. 4, a display panel 131 according to an embodiment of the present invention may be utilized such that a schedule management screen is displayed. As illustrated in an example of a screen of reference numeral 410, the user may display a plurality of registered schedules to be divided into dates and times.

If approach of the stylus 200 is sensed in a displayed location of a meal schedule 1, the controller 110 may control the display panel 131 to output a time change affordance image 41 in the form of “—” capable of adjusting a time of the meal schedule 1 as illustrated in an example of a screen of reference numeral 420. The time change affordance image 41 is not limited to be displayed in the form of “—”. That is, the time change affordance image 41 may be expressed in various forms according to intention of a designer.

To change a time of the meal schedule 1 in an output state of the time change affordance image 41, as illustrated in an example of a screen of reference numeral 430, the user may touch the time change affordance image 41 by the stylus 200, and moves the touch (e.g., drag) to change an end time of the meal schedule 1. Conversely, a touch is sensed on a region other than a time change affordance image 41 among a display region of the meal schedule 1, the controller 110 may control such that a corresponding function (e.g., view of detailed specification) is performed.

Meanwhile, the foregoing embodiment has illustrated that the controller 110 controls such that a time change function is performed when the time change affordance image 41 is touched. Furthermore, it has illustrated that when the region that the time change affordance image 41 is not outputted among a display region of the meat schedule 1 is touched, the controller 110 controls such that a function (output of details) corresponding to selection of the meal schedule 1 is performed. However, the present invention is riot limited thereto. For example, another embodiment of the present invention may set a region spaced apart from an edge of the display region of the meat schedule 1 by a predetermined distance as a first virtual region of a display region of a meal schedule 1 and set a region except for the first virtual region included in the display region of the meal schedule 1 as second virtual region. When it is determined that a stylus 200 approaches the first virtual region, the controller 110 may control such that a time change affordance image 41 indicating that a time may be changed. When the stylus 200 approaches the second virtual region, the controller 110 may control such that a selection affordance image indicating that the meal schedule 1 may be selected is displayed or display of the affordance image is omitted.

When approach of the stylus 200 is sensed, the present invention mentioned above may display a time change affordance image 41 at one side of the display region of the meal schedule 1 to easily change a time period of the meal schedule. However, the related art needs to change a due date of a schedule through a plurality of steps. For example, the related art long-touches the schedule to activate a time change mode, and changes, when the time change mode is activated, a due date of the schedule through an additional touch input. Further, the related art needs to touch the schedule to output a detailed report and change a due date of the schedule on a detailed report screen. That is, the present invention may change a due date of the schedule rapidly, easily, and conveniently as compared with the related art.

In the meantime, FIG. 4 illustrates that only a time change affordance image capable of changing an end time of a schedule is displayed. However, the present invention is not limited thereto. That is, for example, the controller 110 may further output a time change affordance image capable of a start time, a start date, and an end date when approach of the stylus 200 is sensed.

Further, although not shown in FIG. 4, when approach of a touch input device (e.g., finger) other than the stylus 200 is sensed, the controller 110 may disregard sensing the approach. That is, when a touch input device (e.g., finger) other than the stylus 200 is approached, the controller 110 may control such that no image is outputted. This reason is because it is difficult to touch an affordance image having a relatively small size displayed on a side of a display region. In this case, the user may touch a schedule to confirm a detailed report or long-touches the schedule to active a predetermined time change mode.

In another embodiment of the present invention, when approach of a touch input device (e.g., finger) other than the stylus 200 is sensed, the controller 110 may output another affordance image distinguished from an affordance image (e.g., time change affordance image) displayed when approach of the stylus 200 is sensed. For instance, the controller 110 may output an affordance image indicating that the schedule may be selected.

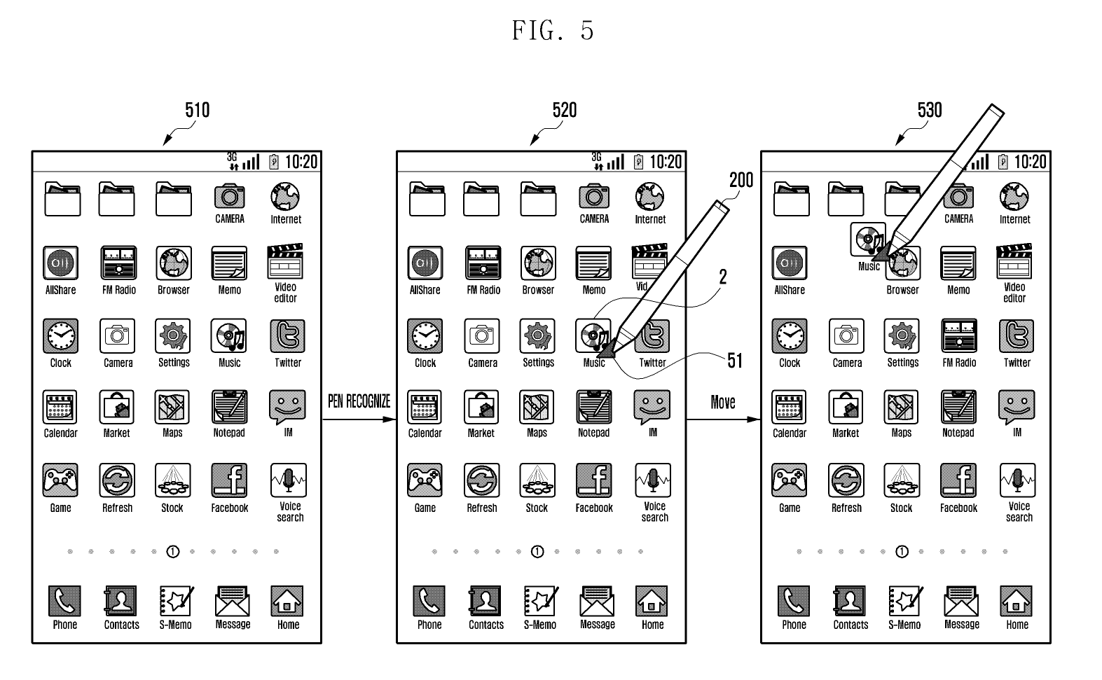

FIG. 5 is a view illustrating an example of a screen for expressing an example of an interface providing an affordance image when a stylus approaches a home screen according to an embodiment of the present invention.

Referring to FIG. 5, a controller 110 according to an embodiment of the present invention may control the display panel 131 to display a home screen. As illustrated in an example of a screen in reference numeral 510, a plurality of icons may be arranged and displayed in multiple-rows and multiple-columns.

If approach of the stylus 200 is sensed on the home screen, as illustrated in an example of a screen of reference numeral 520, the controller 110 may provide output of a moving affordance image 51 to which an icon moving function is set at one side of the music icon 2 which is approached by the stylus 200. FIG. 5 illustrates that the moving affordance image 51 has a form of “ [symbol] ”, and is displayed at a lower right end of the music icon 2. However, the present invention is not limited thereto and the moving affordance image may take any number of forms as determined by a designer. That is, a form and a display location of the moving affordance image 51 may be variously set.

In a state that the moving affordance image 51 is output at one side of the music icon 2, as illustrated in an example of a screen of reference numeral 530, the user may touch the moving affordance image 51 by a stylus 2 and moves the point of contact of the stylus and screen (e.g., drag) to change a location of the music icon 2. In the meantime, when a touch is sensed on a display region of the music icon 2, the controller 110 may control such that a music play function set to the music icon 2 is performed.

As described above, unlike the related art, the present invention may easily move an icon without using a plurality of steps. In detail, the related art long-touches a music icon 2 to activate an icon moving function and moves the icon through a drag. However, when approach of the stylus 200 is sensed, the present invention touches and then drags a moving affordance image displayed on one side of an icon to perform an icon moving function rapidly, easily, and conveniently.

Meanwhile, as illustrated in FIG. 4, the controller 110 classifies a display region of the music icon 2 into a first virtual region and a second virtual region. When approach of the stylus 200 is approached on the first virtual region, the controller 110 may control such that a time change affordance image 41 displaying that the due data can be changed can be displayed. When approach of the stylus 200 is sensed on the second virtual region, the controller 110 may control such that a selection affordance image corresponding to selection is outputted or no image is outputted.

In the meantime, FIG. 5 illustrates that a location of an icon displayed on the home screen is changed. However, the present invention is not limited thereto. For example, when approach of the stylus 200 is sensed, the controller 110 may display a size change affordance image for changing the size of the icon. In the size change affordance image, a widget whose the size is changed such as a weather widget or a schedule widget is applicable to a home screen.

Moreover, although not shown in FIG. 5, when approach of a touch input device (e.g., finger) is sensed, the controller 110 may disregard sensing the approach. That is, when the touch input device (e.g., finger) the controller 110 may control such that no image is outputted. This reason is because it is difficult to touch an affordance image having a relatively small size displayed on a side of a display region. In this case, the user may long-touch an icon to perform an icon moving function.

In another embodiment of the present invention, when approach of a touch input device (e.g., finger) other than the stylus 200 is sensed, the controller 110 may output another affordance image distinguished from an affordance image (e.g., moving affordance image) displayed when approach of the stylus 200 is sensed. For instance, the controller 110 may output an affordance image indicating that the music icon 2 may be selected.

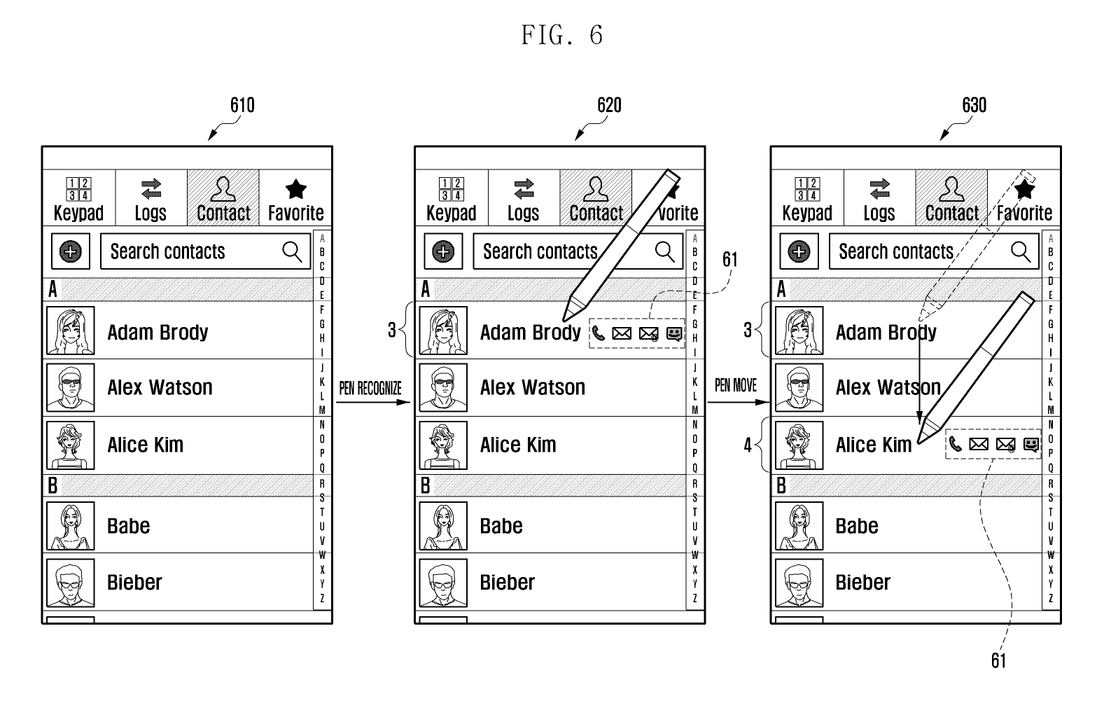

FIG. 6 is a view illustrating an example of a screen for expressing an example of an interface providing an affordance image when a stylus approaches a screen of an address book.

Referring to FIG. 6, a controller 110 according to an embodiment of the present invention may control a display panel 131 to display an address book screen. As illustrated in an example of a screen of reference numeral 610, the address book screen may display contact information registered in the portable terminal 100 in the form of a list.

If approach of a stylus 200 approaches a first contact information field 3, as illustrated in an example of a screen of reference numeral 620, the controller 110 may provide control such that a function affordance image 61 is output to a side of the first contact information field 3. The function affordance image 61 may include icons indicating executable functions, for example, a call icon, a character icon, an e-mail icon, and an instant image icon using information (phone number, e-mail address, instant message ID, etc.) registered in corresponding contact information.

When the touch screen is in a state that the function affordance image 61 is output, the user may touch one of icons included in the function affordance image 61 by the stylus 200 to perform a corresponding function. For example, when the user touches a call icon, the controller 110 may request a call using a phone number of the corresponding contact information.

Meanwhile, when the user touches a region on which a function affordance image 61 is not displayed among display regions of the first contact point field 3, the controller 110 may output a detailed information screen of the first contact point.

In the meantime, when the user does not touch an icon included in a function affordance image 61 but moves the stylus 200 to another contact information field, the controller 110 may move the function affordance image 61 to another contact information field. For example, as illustrated in an example of a screen in reference numeral 630, when the user moves the stylus 200 to a second contact information field 4, the controller 110 may control such that the function affordance image 61 is displayed at a side of the second contact information field 4.

As described above, unlike the related art, the present invention may easily perform a certain function without using a plurality of steps. In detail, conventionally, after touching or long-touching a contact point field to output a function list in the form of a pop-up window, the user should select a desired function (character message, call, e-mail, etc.). However, when approach of the stylus 200 is sensed, the present invention touches one of icons included in a function affordance image displayed on one side of a contact point field to perform a desired function rapidly, easily, and conveniently.

In addition, although not shown in FIG. 6, when approach of a touch input device (e.g., finger) other than the stylus 200 is sensed, the controller 110 may disregard sensing the approach. That is, when the touch input device (e.g., finger) other than the stylus 200 is approached, the controller 110 may control such that no image is outputted. The reason is because it is difficult to touch an affordance image having a relatively small size displayed on one side of a display region of the icon using the finger. For example, when the user attempts touching a character message icon using the finger, the user firstly touches a call icon due to the finger having a relatively large size.

In the present invention mentioned above, when approach of the stylus 200 is sensed, an affordance image having a controlling function through a stylus with a small touch region, namely, a function for which a precise touch is requested is output. When approach of the stylus 200 is not sensed, that is, when approach of a finger is sensed, it may control a display panel 131 to output an affordance image including a function for which a precise touch is not requested. Accordingly, the present invention may output a suitable affordance image according to situations but not output unnecessary image on a screen to improve convenience for the user. When the touch approach other than touch sensing is sensed, the present invention may rapidly perform a desired function of the user according to output of an affordance image.

As illustrated above, in a method of providing a user interface of a portable terminal and an apparatus thereof according to embodiments of the present invention, when approach of a touch input device is sensed on a touch screen, an affordance image is output and one of icons included in the affordance image is touched to perform a desired function. Therefore, the present invention may rapidly perform a desired function without processing a plurality of steps. Further, the present invention may output an affordance image corresponding to types of touch input devices. Accordingly, the present invention may provide a suitable affordance image according to situations to enhance the convenience for the user.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor, microprocessor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of providing a user interface of a portable terminal with a touch screen, the method comprising:
checking whether approach of a touch input device is sensed on said touch screen;
determining a type of said sensed touch input device when the approach of said touch input device is sensed; and
outputting a first affordance image corresponding to at least one function executable using a stylus at a sensed region of the approach of the stylus when said touch input device is said stylus as the determination result.

2. The method of claim 1, wherein said checking whether approach of a touch input device is sensed on said touch screen comprises checking whether said touch input device approaches one of items displayed on said touch screen.

3. The method of claim 1, wherein said determining of the type of said sensed touch input device comprises:
determining said stylus as said touch input device when approach of said touch input device is sensed through an electromagnetic induction touch panel; and
determining a touch input device distinguished from said stylus as said touch input device when approach of said touch input device is sensed through a capacitive touch panel.

4. The method of claim 1, further comprising
performing one of said at least one function corresponding to said touch event when a touch event is sensed on said first affordance image.

5. The method of claim 3, further comprising one of:
outputting a second affordance image corresponding to at least one other function executable using the said touch input device distinguished from said stylus, wherein the at least one other function is different from the at least one function executable using the stylus, on a region which said approach of said touch input device distinguished from said stylus is sensed when said touch input device is said touch input device distinguished from said stylus; and
disregarding approach of said touch input device distinguished from said stylus when said touch input device is said touch input device distinguished from said stylus as said determination result.

6. The method of claim 5, further comprising executing one of said at least one other function corresponding to a touch event when said touch event is sensed on said second affordance image.

7. The method of claim 5, wherein said first affordance image and said second affordance image comprise at least one function icon to which a certain function is set.

8. The method of claim 7, wherein said function icons included in said first affordance image and said second affordance image are changed according to a type of icon located at a region which said touch input device approaches.

9. The method of claim 5, further comprising moving said first affordance image or said second affordance image according to movement of said touch input device when the movement of said touch input device is sensed in a state that said touch input device approaches said touch screen.

10. The method of claim 1, further comprising:
determining whether an affordance image display mode displaying an affordance image at a sensed region of the approach of said touch input device is activated; and
performing said determining said type of said sensed touch input device when said affordance image display mode is activated.

11. An apparatus for providing a user interface of a portable terminal, the apparatus comprising:
a touch panel recognizing approach and touch of a touch input device;
a controller determining a type of said touch input device when approach of said touch input device is sensed, and controlling such that a first affordance image corresponding at least one function executable using a stylus at a side of a sensed region of approach of said stylus is displayed when said touch input device is said stylus as said determination result; and
a display panel outputting said first affordance image.

12. The apparatus of claim 11, wherein said controller checks whether said touch input device approaches one of items displayed on said touch screen.

13. The apparatus of claim 11, wherein said controller executes one of said at least one function in response to a sensed touch event when said touch event is sensed on said first affordance image.

14. The apparatus of claim 11, wherein said controller outputs a second affordance image corresponding to at least one other function executable using said touch input device distinguished from said stylus, wherein the at least one other function is different from the at least one function executable using said stylus to a location in which the approach of said touch input device is sensed when said touch input device is distinguished from said stylus.

15. The apparatus of claim 14, wherein said controller executes one of said at least one other function corresponding to a touch event when said touch event is sensed on said second affordance image.

16. The apparatus of claim 14, wherein said first affordance image and said second affordance image comprise at least one function icon to which a certain function is set.

17. The apparatus of claim 16, wherein said controller changes a function icon included in said first affordance image or said second affordance image according to a type of an item located in a region which said touch input device approaches.

18. The apparatus of claim 14, wherein said controller moves said first affordance image or said second affordance image according to a movement of said touch input device when the movement of said touch input device is sensed in a state that said touch input device approaches said touch screen.

19. The apparatus of claim 11, wherein said controller disregards the approach of said touch input device when said touch input device is distinguished from said stylus as said determination result.

20. The apparatus of claim 11, wherein said controller determines whether an affordance image display mode displaying an affordance image at a sensed region of the approach of said touch input device is activated; and determines a type of said sensed touch input device when said affordance image display mode is activated.

21. The apparatus of claim 11, wherein said touch panel is a combination touch panel being a combination of a capacitive touch panel and an electromagnetic induction touch panel.

22. The apparatus of claim 21, wherein said controller determines that said stylus approaches when the approach of said touch input device is sensed through said electromagnetic induction touch panel, and determines that a touch input device distinguished from said stylus approaches when the approach of said touch input device is sensed through said capacitive touch panel.

23. The apparatus of claim 11, wherein said touch panel is a combination touch panel being a combination of a resistive touch panel and an electromagnetic induction touch panel.

24. A method of providing a user interface of a portable terminal with a touch screen, the method comprising:
sensing approach of a stylus; and
outputting an affordance image corresponding to at least one function executable using said stylus at a sensed region of the approach of a stylus when the approach of said stylus is sensed.

25. An apparatus for providing a user interface of a portable terminal, the apparatus comprising:
a touch screen sensing approach of a stylus; and
a controller for controlling said touch screen to output an affordance image corresponding to at least one function executable using said stylus at a sensed region of the approach of said stylus when the approach of said stylus is sensed.
